(19) United States
(12) Patent Application Publication
(10) Pub. No.: US 2008/0296910 A1
(43) Pub. Date: Dec. 4, 2008

(54) POWER GENERATION CONTROL DEVICE AND VEHICLE HAVING THE SAME

(75) Inventor: Kazuo Sato, Shizuoka-ken (JP)

Correspondence Address: KNOBBE MARTENS OLSON & BEAR LLP, 2040 MAIN STREET, FOURTEENTH FLOOR, IRVINE, CA, 92614, US

(73) Assignee: YAMAHA MOTOR ELECTRONICS KABUSHIKI KAISHA, Shizuoka-ken (JP)

(21) Appl. No.: 12/122,576

(22) Filed: May 16, 2008

(30) Foreign Application Priority Data
May 28, 2007 (JP) JP2007-140117

(51) Int. Cl. H02P 9/04

(52) U.S. Cl. 290/40 R

(57) ABSTRACT

A power generation control device for determining a crank position of an engine to reduce a start-up torque following an engine stop, enhancing startability, and reducing electric power consumption of a battery at start-up is provided. The power generation control device includes a magneto generator rotated by an engine, a generated electric current controller that rectifies an alternating electric current generated by the magneto into a direct current and supplies the direct current as a generated electric current to an electric appliance and controls a power generation amount to the electric appliance. A controlling section controls a power generation amount of a rectifying section. The controlling section is provided with an exhaust stroke stop estimation time control module for calculating engine rotational speed and acceleration values based on a signal related to a rotation cycle of a crankshaft or the magneto generator, for estimating a stop of the engine according to the rotational speed and the acceleration values, and for performing a control for increasing the power generation amount of the rectifying section when the engine stop is estimated to occur at an exhaust stroke of the engine.

### CROSS-REFERENCE TO RELATED APPLICATIONS

This application is based upon and claims priority under 35 U.S.C. § 119 to Japanese patent application Serial No. 2007-140117, filed May 28, 2007, the entire contents of which is hereby incorporated by reference.

### BACKGROUND OF THE INVENTION

1. Field of the Invention

The present invention relates to a power generation control device and more particularly to a power generation control device for rectifying an alternating current generated from a magneto generator driven with an engine (e.g., internal combustion engine) to a direct current and controlling a power generation amount, and to a vehicle having such a power generation control device.

2. Description of the Related Art

FIG. 5(a) to (d) are vertical cross-sectional views illustrating a cycle operation of a single cylinder four cycle engine, where FIG. 5(a) illustrates an intake stroke, FIG. 5(b) illustrates a compression stroke, FIG. 5(c) shows an explosion stroke, and FIG. 5(d) illustrates an exhaust stroke. In FIG. 5(a) to (d), 1 illustrates an engine, 1a a piston, 1b an intake valve, 1c an exhaust valve, 1d an inlet port, 1e an exhaust port, and 2a a center position of a crankshaft.

In FIG. 5(a) to (d), when the engine stops during the compression stroke or the explosion stroke, because the inlet valve 1b and the exhaust valve 1c are both closed, a large start-up torque exists at the next engine start, and electric power consumption of a starter motor increases. On the other hand, when the engine 1 stops during the exhaust stroke or the intake stroke, because the exhaust valve 1c or the inlet valve 1b is open, the start torque is small at the next engine start, and the power consumption of the starter motor can be reduced.

Therefore, it is desirable to control the engine 1 to stop at the exhaust stroke or the intake stroke.

A conventional power generation control device 10 illustrated in FIG. 4 can be mounted on a straddle-type vehicle such as a motorcycle of a kick-starter type.

The power generation control device 10 is of a constitution in which a three-phase alternating electric current is generated with a magneto generator 11 rotatably driven by the rotation of a crankshaft 2 of an internal combustion engine 1 and rectified to a direct current by a regulator 12. This generated electric current is supplied to an electric appliance 14 (e.g., a headlamp 14a, a brake lamp 14b, and other electric appliances 14c). A generated electric current from a battery 13 provided in parallel with the regulator 12 is supplied to the electric appliance 14.

At a start time of the engine 1, a starter motor (not shown; included in the other electric appliances 14c) initially rotates the crankshaft 2, power generation control is performed by the regulator 12 after start-up, and power generation control is performed by varying a generated electric current Ix corresponding to a change of a load electric current Iy.

A function for controlling an angle of the crankshaft at engine stop is not included in the power generation control device 10 illustrated in FIG. 4 of such a constitution.

According to a start aid device of an engine disclosed in Japanese Patent Publication No. JP 2005-248780, a compression pressure of a combustion chamber is reduced by slightly opening at least one of an intake valve and an exhaust valve via a mechanical design for a mechanism having a driving valve cam, a cam shaft, a decompression shaft, and a release lever during a compression stroke in which the rpm of the engine is low.

However, according to the start aid device of the engine disclosed in JP 2005-248780, the degree of freedom is small.

In the power generation control device 10 illustrated in FIG. 4, because the engine cannot be controlled to stop at the exhaust stroke or the intake stroke, a determination is made in a course of events with an angle of the crankshaft at an engine stop time according to various situations at a time when the engine is stopped. At a next start time, because a starting torque varies according to a crank position, a starting device (a motor and a battery) able to perform a stable start even at a maximum starting torque time is needed. Moreover, at an engine start time, if rotation starts from the compression stroke, a large starting torque able to overcome a cylinder internal pressure is needed. In that case, startability is bad, and consumed electric power at the start time becomes large.

### SUMMARY OF THE INVENTION

In view of the circumstances discussed above, one aspect of the invention is to provide a power generation control device for setting an engine crank position to make a start-up torque small, enhancing startability of the engine, and reducing battery-consumed electric power at start-up, and to vehicle having such a power generation control device.

In accordance with one aspect of the present invention, a power generation control device is provided. The power generation control device comprises a magneto generator configured to generate an alternating electric current, the magneto generator rotatably driven by a crankshaft of an engine. A generated electric current controller is configured to rectify the alternating electric current into a direct current to provide a generated electric current, and to supply the generated electric current to at least one electric appliance, the generated electric current controller further configured to control a power generation amount to the at least one electric appliance. A battery is connected in parallel with the generated electric current controller and with respect to the electric appliance. The generated electric current controller comprises a rectifying section for converting the alternating electric current generated by the magneto generator to a direct current, and a controlling section for controlling a power generation amount of the rectifying section. The controlling section comprise an exhaust stroke stop estimation time control module for calculating engine rotational speed and acceleration values based at least in part on a signal related to a rotation cycle of the crankshaft or the magneto generator, for estimating a stop position of the engine according to the rotational speed and the acceleration values, and for increasing the power generation amount of the rectifying section when the exhaust stroke stop estimation time control module estimates that the engine stops at an exhaust stroke.

In accordance with another aspect of the present invention, a power generation control device is provided. The power generation control device comprises a magneto generator configured to generate an alternating electric current, the magneto generator rotatably driven by a crankshaft of an engine. A generated electric current controller is configured to rectify the alternating electric current into a direct current to provide a generated electric current, and to supply the generated electric current to at least one electric appliance, the generated electric current controller further configured to control a power generation amount to the at least one electric appliance. The power generation control device further comprises means for variably controlling a rectifying section of the generated electric current controller so that the generated electric current of the rectifying section corresponds to an operation mode of the engine and for estimating a stop position of the engine. The generated electric current controller configured to increase the power generation amount of the rectifying section when the engine is estimated to stop at an exhaust stroke.

In accordance with still another aspect of the present invention, a method for controlling a power generation control device is provided. The method comprises generating an alternating electric current via a generator driven by an engine, rectifying the alternating electric current into a direct current to provide a generated electric current, supplying the generated electric current to at least one electric appliance, and controlling a power generation amount to the at least one electric appliance. The method further comprises calculating rotational speed and acceleration values of the engine based at least in part on a signal corresponding to a rotation cycle of a crankshaft of the engine or the generator, estimating a stop position of the engine according to the calculated rotational speed and acceleration values, and increasing the power generation amount when it is estimated that the stop position of the engine is at an exhaust stroke of the engine.

### BRIEF DESCRIPTION OF THE DRAWINGS

These and other features, aspects and advantages of the present inventions will now be described in connection with preferred embodiments, in reference to the accompanying drawings. The illustrated embodiments, however, are merely examples and are not intended to limit the inventions. The drawings include the following 5 figures.

FIG. 1 is a circuit diagram of a power generation control device according to a first embodiment of the present invention.

FIGS. 2(a)-(f) are explanatory drawings illustrating a relation between a phase angle control and output currents of a controlling section of the power generation control device in FIG. 1.

FIG. 3 is a flowchart illustrating one embodiment of a control method of a control section of the power generation device in FIG. 1.

FIG. 4 is a circuit diagram of a conventional power generation control device of a conventional kick-starter type vehicle.

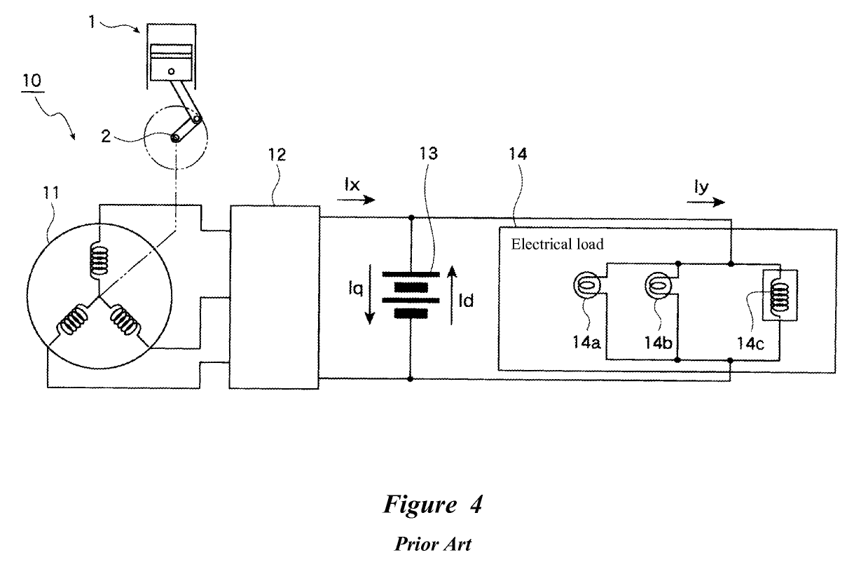

FIG. 5(a)-(d) are vertical cross-sectional views illustrating a cycle operation of a conventional single cylinder four cycle engine.

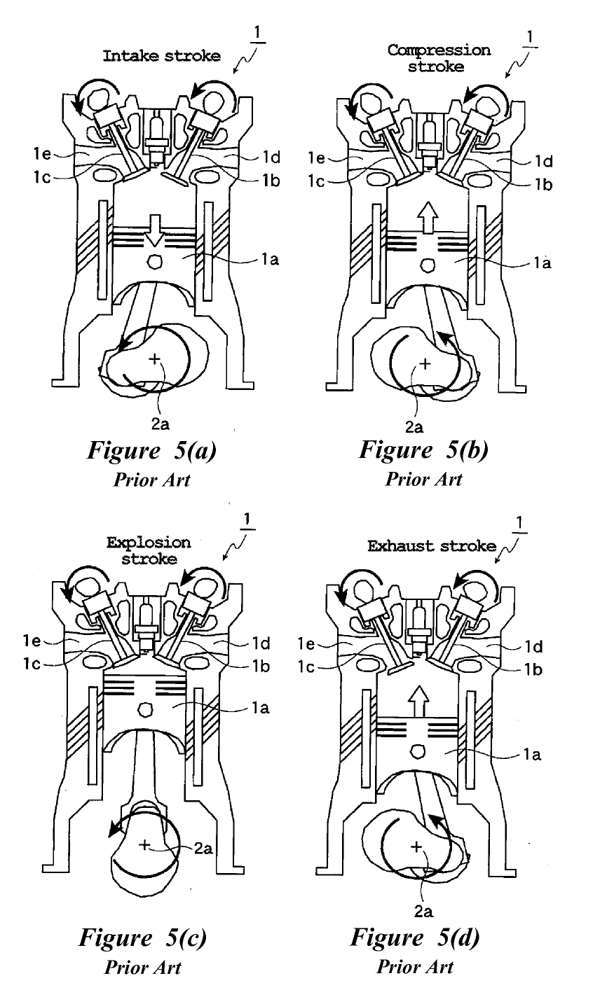

### DETAILED DESCRIPTION OF THE PREFERRED EMBODIMENTS

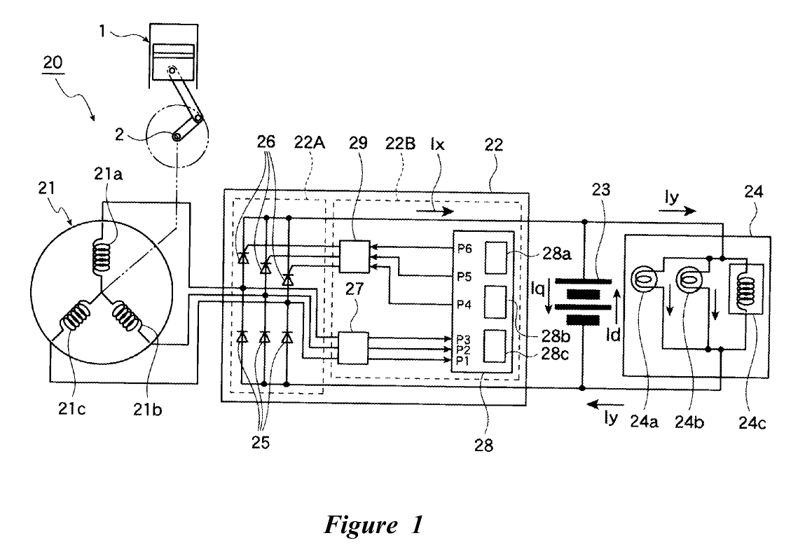

FIGS. 1-3 illustrate a power generation control device that can be used with a vehicle, such as a straddle-type vehicle (e.g., a motorcycle). Additionally, the inventions disclosed herein are not limited to a so-called motorcycle-type two-wheel vehicle, but are applicable to other types of two-wheel vehicles. Furthermore, some aspects of the inventions disclosed herein are not limited to straddle-type vehicles, but can also be used with vehicles with side-by-side seating.

As illustrated in FIG. 1, a power generation control device 20 can have a magneto generator 21 that generates an alternating electric current. A generated electric current controller 22 can rectify the generated alternating electric current to a direct current and can control a power generation amount, the generated electric current controller 22 supplying the direct current to an electric appliance 24. A battery 23 can be connected in parallel with the generated electric current controller 22 and with respect to the electric appliance 24.

The magneto generator 21 can be a magnet type three-phase alternating current power generator which is driven by the rotation of the crankshaft 2 of an engine (e.g., an internal combustion engine) 1 and in which a permanent magnet (not shown) can be attached to a rotor that rotates relative to stator coils 21a to 21c.

The generated electric current controller 22 can be a circuit section that converts the alternating current generated by the magneto generator 21 to a direct electric current and controlling the generated electric current. The generated electric current controller 22 can have a rectifying section 22A and a controlling section 22B.

The battery 23 can supply a discharge electric current Id to the electric appliance 24 when a generated electric current Ix from the generated electric current controller 22 is smaller than a load electric current Iy of the electric appliance 24. The battery 23 can be supplied with a charging electric current Iq when the generated electric current Ix is larger than the load electric current Iy.

With continued reference to FIG. 1, the electric appliance 24 can include a headlamp 24a, a brake lamp 24b, and other electric appliances 24c. The other electric appliances 24c can include at least one of an ignition control controller, an engine control unit, a fuel injection (FI) controller, a tail lamp, a stop lamp, a neutral indicator, a meter, an electromotion pump and the like.

The rectifying section 22A can be a circuit section for converting the alternating current generated by the magneto generator 21 to a direct electric current. This rectifying section 22A can constitute a three-phase bridge mixed connection performed with a circuit serially connecting a diode 25 of an upstream side and a thyristor 26 of a downstream side, where an alternating electric current induced in each stator coil 21a to 21c of the magneto generator 21 is input to a position between the diode 25 and the thyristor 26.

The rectifying section 22A is so constituted that conduction (e.g., turning on) is performed between an anode and a cathode of the thyristor 26 to variably output a generated electric current by inputting an electric current of a constant level output from a trigger signal output circuit 29 described later to a gate of each thyristor 26.

To stop (e.g., to turn off) the conduction of the thyristor 26, the electric current between the cathode and the anode is made to become equal to or lower than a certain value. Here, turning off of the conduction of the thyristor 26 can occur when the alternating current becomes equal to a certain value or lower.

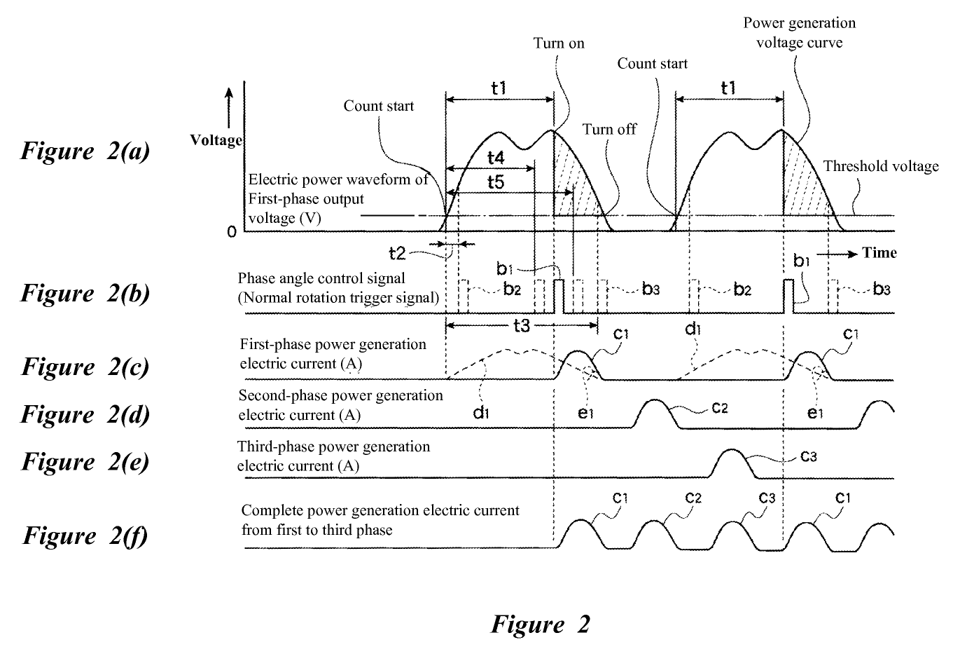

In one embodiment, a power generation amount can be variably output by a phase angle control, as illustrated with reference to FIG. 2. FIG. 2(a) illustrates power generation voltage curves between the diode 25 and the thyristor 26 of a first phase as a function of time. The phase angle control can detect a level of the power generation voltage, detects a time when a threshold value is reached or exceeded, starts a count from this time, and outputs a phase angle control signal (trigger signal) b1 at a timing when a time t1 illustrated in FIG. 2(b) has passed. Consequently, the thyristor 26 turns on, and a hatched area from the turn on to turn off points of FIG. 2(a) becomes an electric current value c1 illustrated in FIG. 2(c) to be output from the thyristor 26 of the first phase. The electric current illustrated in FIG. 2(c) is equivalent to one phase. An electric current of a second phase and an electric current of a third phase are illustrated in FIG. 2(d) and FIG. 2(e). Electric currents of three phases from FIG. 2(c) to FIG. 2(e) are compounded to be a composite generated electric current illustrated in FIG. 2(f) and output from the rectifying section 22A.

The hatched area of FIG. 2(a) illustrates levels of electric currents. When a count time becomes small as indicated with t2 (e.g., an output timing of the trigger signal is shifted to the left), and if a trigger signal b2 is output, a power generation amount becomes large as indicated with d1. In contrast, when the count time becomes large as indicated with t3 (e.g., the output timing of the trigger signal is shifted to the right), and if a trigger signal b3 is output, a power generation amount becomes small as indicated with e1. The count times t1, t2, and t3 are given by converting a ratio of phase angle data found in a rotation cycle to a time.

With reference to FIG. 1, the controlling section 22B can have a voltage detection circuit 27, a microcomputer 28, and the trigger signal output circuit 29.

The voltage detection circuit 27 can receive as input a frequency signal from the stator coils 21a to 21c (three phases of the rectifying section 22A) and output a voltage corresponding to a change of the frequency signal regarding the three phases so that voltages of the three phases (e.g., signals related to a rotation cycle) are input to three analog ports P1, P2, and P3 of the microcomputer 28.

The microcomputer 28 can store phase angle data used for an output timing of the trigger signal output to a gate of each thyristor 26 of the rectifying section 22A in a ROM 28c as a nonvolatile memory corresponding to each operation mode determined depending on rotational speed and acceleration of the internal combustion engine.

The phase angle data can be stored in the ROM 28c, for example, by repeating driving experiments with respect to sudden acceleration and sudden deceleration to determine a range of a value of rotational speed and a range of a value of acceleration and thereby determining an appropriate target power generation amount from a viewpoint of energy saving operation so that a target power generation amount can be determined and read out according to a relation between rotational speed and acceleration at a certain time.

The phase angle data can correspond to a trigger signal output time corresponding to the rotation cycle time illustrated in FIG. 2(a).

When the phase angle data stored in the ROM 28c is converted to the trigger signal output time, a relation below can be provided in one embodiment. (1) When the operation mode is of a start-up (e.g., from the rotational speed of 0 rpm to, for example, 2000 rpm), corresponding phase angle data is set so that the trigger signal output instruction signal b3 is output with the longest time t3 (see FIG. 2), or a setting is made not to output the trigger signal output instruction signal. (2) When the operation mode is of an idling state, corresponding phase angle data is set so that the trigger signal output instruction signal b2 with the shortest time t2 (see FIG. 2) is output. (3) When the operation mode is of an acceleration state, a setting is made to make the trigger signal output time longer than a time of a constant speed operation mode to which a current engine rotational speed belongs (e.g., to make a power generation amount small). (4) When the operation mode is of an deceleration state, a setting is made to make the trigger signal output time shorter than the current time, and the phase angle data is set to not drain the battery charge, the power generation amount being sufficiently larger than the load electric current of the electric appliance 24 so that the battery 23 can be charged. (5) When the operation mode is one in which a headlamp is lit, a setting is made to make the trigger signal output time longer than that of a time of an operation mode in a state in which the headlamp is off, and the phase angle data is set so that the power generation amount not causing a battery exhaustion is given when a long time operation is performed. (6) When the operation mode is of a high speed constant state, a setting is made to make the trigger signal output time shorter than that of a time of a medium speed constant state or a low speed constant state. As for the trigger signal output time in the medium speed constant state or the low speed constant state, the phase angle data is set so that the power generation amount not causing a battery exhaustion is given when a long time operation is performed.

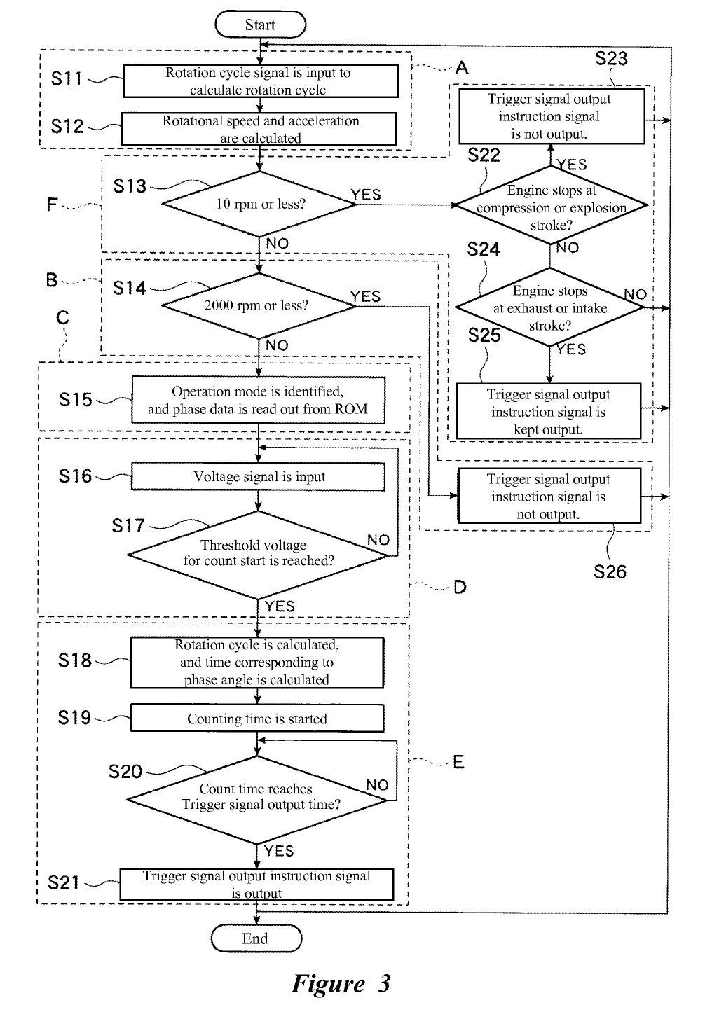

With continued reference to FIGS. 1-3, the microcomputer 28 can have a rotational speed and acceleration calculation module (e.g., a part of A of a flowchart in FIG. 3), which can include software stored in a nonvolatile memory 28b, an engine start time output control module (e.g., a part of B of the flowchart in FIG. 3), a normal operation time output control module (e.g., a part of C of the flowchart in FIG. 3), a count start time determination module (e.g., a part of D of the flowchart in FIG. 3), a trigger signal output instruction module (e.g., a part of E of the flowchart in FIG. 3), and an engine stop-time output control module (e.g., a part of F of the flowchart in FIG. 3).

The rotational speed and acceleration calculation module A can input a signal in relation to a rotation cycle of the magneto generator 21 (or the crankshaft 2) from the voltage detection circuit 27 to calculate rotational speed and acceleration values.

Until the engine rotational speed calculated by the rotational speed and acceleration calculation module A becomes 2000 rpm, the engine start time output control module B can make the generated electric current of the rectifying section 22A become zero or about zero to make the power generation torque become zero or about zero.

If the engine rotational speed exceeds 2000 rpm, the normal operation time output control module C can identify an operation mode by the rotational speed and the acceleration values and read out a phase angle corresponding to the operation mode from the nonvolatile memory 28c to define a phase angle for a timing setting.

After the phase angle data is read out by the normal operation time output control module C, the count start time determination module D can input a voltage signal of the magneto generator 21 to determine whether or not the voltage value of the voltage signal reaches the threshold voltage for starting to calculate the phase angle.

The trigger signal output instruction module E can calculate the phase angle at times from the count start time determined by the count start time determination module, can determine whether or not the phase angle becomes equal to the phase angle for the timing setting, and, when it becomes equal, can output the trigger signal output instruction signal.

The engine stop time output control module F can perform power generation control immediately before the engine 1 stops, determine whether or not the engine rotational speed calculated by the rotational speed and acceleration calculation module A becomes 10 rpm or less, can further estimate the stop of the engine 1 on the basis of the rotational speed and the acceleration values when the engine rotational speed becomes equal to 10 rpm or less, performs control for increasing the power generation amount of the rectifying section when it is estimated that the engine stops at the exhaust stroke (e.g., the exhaust stroke stop estimation time control module: the step S22 to the step S24), perform control for making the power generation amount of the rectifying section become zero until the compression stroke is exceeded when it is estimated that the engine stops between the intake stroke and the compression stroke in which the intake and exhaust valves are closed (e.g., the compression stroke stop estimation time control module: the step S22 to the step S23). The engine stop time output control module F can also estimate again the stop of the engine 1 on the basis of the rotational speed and the acceleration values, and controls an increase in the power generation amount of the rectifying section when it is estimated that the engine stops at the exhaust stroke (e.g., the exhaust stroke stop estimation time control module: the step S22 to the step S24).

With continued reference to FIG. 1, the microcomputer 28 can have a CPU 28a that can read out the program software stored in the ROM 28b or other nonvolatile memory, can calculate the rotational speed and acceleration on the basis of the signal in relation to the rotation cycle input from the three analog ports p1 to p3 by the rotational speed and acceleration calculation module A first, and can make the generated electric current of the rectifying section 22A become zero or about zero until the engine rotational speed becomes 2000 rpm by the engine start time output control module B so that the power generation torque becomes zero or about zero for the power generation load torque not to be applied to the crankshaft 2 of the engine 1. Following this, when the engine rotational speed exceeds 2000 rpm, an operation mode can be identified with rotational speed and acceleration values by the normal operation time output control module C, a phase angle corresponding to the operation mode can be read out from the nonvolatile memory 28c as a phase angle for a timing setting, and a timing time corresponding to the rotation cycle at this time can be calculated and stored in a resistor. Following this, the voltage signal of the magneto generator 21 can be input by the count start time determination module D, and a count start time when the voltage value of the voltage signal reaches the threshold voltage for starting to calculate the phase angle can be detected. Additionally, the count time of the phase angle for the timing setting with the phase angle for the timing setting or correction regarding the rotation cycle applied can be calculated by the trigger signal output instruction module E following the previous step, and the trigger signal output instruction signal can be output when the time comes by counting from the count start time (e.g., when the phase angle is determined to be equal to the phase angle for the timing setting) to perform the power generation control of the normal operation time.

Identification of the operation mode at this time is performed regarding operation modes defined beforehand such as, for example, an idling state, a start time, a low speed rotation running state, a middle speed rotation running state, a high speed rotation running state, a sudden acceleration state, a gradual acceleration state, a sudden deceleration state, a gradual deceleration state, and a headlamp lighting state, and the identification is made to be automatically performed from rotational speed and acceleration values. A predefined specific code can be automatically given to an identified mode. An operation mode can be identified by storing phase angle data corresponding to specific codes in the ROM 28c, and the phase angle data stored in the ROM 28c can be read by specifying the specific code thereby obtained.

The phase angle data stored in the ROM 28c can be stored in the ROM 28c, for example, by repeating driving experiments with respect to sudden acceleration and sudden deceleration events to determine a range of rotational speed values and a range of acceleration values and by thereby determine an appropriate target power generation amount from a viewpoint of energy saving driving operation so that a target power generation amount can be determined and read out in relation to a rotational speed and acceleration value for a certain time.

The trigger signal output circuit 29 can be so constituted that, when three trigger signal output instruction signals output from three I/O ports p4 to p6 of the microcomputer 28 are input, a trigger signal able to turn on each thyristor 26 by supplying electricity to gates of the three thyristors 26 corresponding to these signals is output.

Therefore, when the trigger signal (e.g., a pulse signal) is input from the trigger signal output circuit 29 to the gates of the three thyristors 26, phase angle control of the rectifying section 22A can be performed so that the generated electric current Ix is desirably variably output.

Moreover, when a clutch is turned off to stop the engine 1, a change of the engine rotational speed can be detected by the engine stop time output control module F to estimate an engine stop, and, if a stop at the exhaust stroke or the intake stroke is estimated, the power generation control can be performed to the maximum immediately before the engine 1 stops (e.g., the step S24 to the step 25 in FIG. 3) so that a maximum power generation load torque is applied to a clutch shaft 2 and utilized as the braking torque of the engine 1. Thus, the engine 1 can be stopped at the exhaust stroke, making a starting torque at a time of a next start be small and reducing battery-consumed electric power at the start time, as well as enhancing startability.

Further, when it is estimated that the engine 1 stops between the intake stroke and the compression stroke in which the exhaust valve and the intake valve are both in a closed valve state, the power generation amount of the rectifying section 22A can be controlled to be zero or about zero (e.g., the step S23 in FIG. 3), the load torque by the power generation of the magneto generator 21 can be made to be zero or about zero to exceed the compression stroke, and, after the stop estimation is postponed to the exhaust stroke or the intake stroke in which either of the exhaust valve and the intake valve is in an open valve state, the power generation amount of the rectifying section 22A can be increased (the step S25 in FIG. 3) to stop the engine 1 at the exhaust stroke or the intake stroke.

The starting torque at a time of the next start thereby becomes small, and a start failure is reduced, enhancing startability and reducing battery-consumed electric power at the start time.

FIG. 3 is a flowchart illustrating one embodiment of a control procedure in which the CPU of the microcomputer 28 can read out program software from the ROM 28b and execute it.

When a start is made, a rotation cycle signal is input first, and a rotation cycle is calculated (step S11). Here, a three-phase detection voltage variably output from the voltage detection circuit 27 can be the rotation cycle signal, and each voltage signal input from the analog ports p1 to p3 is AC-DC converted with 256 gradations so that, for example, a time between peak values of digital values is calculated to calculate a rotation cycle to be stored in a register (e.g., may be stored in a DRAM; hereinafter the same applies).

Following this, rotational speed and acceleration can be calculated (step S12). Here, a predefined calculation can be performed on the basis of the digital value of one phase among the three phases obtained in the step S11 to calculate a rotational speed value to be stored in the register, and, following this, an acceleration value is calculated and stored in the register.

Following this, whether or not the rotational speed calculated in the step S12 is 10 rpm or less is determined (step S13), and, following this, whether or not the rotational speed is 2000 rpm or less is determined (step S14). These determinations can be determined by performing a comparison by using the threshold memorized in the nonvolatile memory 28c.

At an engine start time, there is a brief time when the rotational speed is 10 rpm or less. At this time, although YES is determined in the step S13, acceleration is a positive value, and an engine stop is not estimated so that a circulation proceeding from the step S22, the step S24 to the step S11 is performed. The trigger signal output instruction signal is not output, and the rotational speed immediately becomes 10 rpm or higher so that the determination of whether or not 2000 rpm or less is met is performed (step S14).

In contrast, when the engine stops, the rotational speed is gradually decreased, and the rotational speed calculated in the step S12 becomes 10 rpm or less immediately before the stop. At this time, YES is determined in the step S13, and the step goes to S22.

In the step S22, whether or not the engine 1 stops at the compression or the explosion stroke is estimated (e.g., determined) from a rotation cycle of the crankshaft and the degree of deceleration. When the stop is not estimated, NO is determined, and the step goes to S24. In the step S24, it is estimated (e.g., determined) whether or not the engine 1 stops at the exhaust or the intake stroke. If the stop is not estimated, NO is determined, and the step returns to S11. Because of this, because the trigger signal output instruction signal is not output, the power generation load torque is not generated in the magneto generator 21, and, because the power generation load torque is not applied to the crankshaft 2, if this circulation is performed, the rotation of the engine 1 is continued by a remaining small torque amount.

As described above, when the circulation of the steps S11 to 13 to the steps S22, the step S24, and the step S11 is performed once or a plurality of times, the rotational speed calculated in the step S12 is decreased on every occasion, and, because deceleration becomes large, YES is determined in the step S22. Consequently, also at this time, because the trigger signal output instruction signal is not output (step S23), the rotation of the engine 1 is continued by a remaining small torque amount, and the compression and explosion strokes can be exceeded.

Further, when the step returns from S23 to S11, the rotational speed calculated in the step S12 is further decreased, and because deceleration becomes further large, as this is immediately after a stop at the compression or explosion stroke is avoided, NO is determined this time in the step S22, and YES is determined in the step S24. Consequently, at this time, because the trigger signal output instruction signal is kept output (step S25), power generation control for outputting all or generally all of the voltage induced at the rotational speed as a direct current to the magneto generator 1 is performed. Because of this, a large power generation load torque is generated in the magneto generator 1, this torque is transmitted as a brake to the crankshaft 2, and, therefore, it is possible to stop the engine at the exhaust or intake stroke.

When the rotational speed calculated in the step S12 exceeds 2000 rpm, this means that the start is completed, and there is no possibility that an engine stall occurs so that the step goes to S15.

In the step S15, an operation mode is identified from the rotational speed and acceleration values calculated in the step S12, and a memory readout code corresponding to the identified operation mode is used to read out a phase angle data from the ROM 28c.

Following this, the voltage signal is sampled and input (step S16). Here, three voltage signals output from the voltage detection circuit 27 is sampled and input from the analog ports p1 to p3, and each voltage signal is AC-DC converted with 256 gradations and input to the register.

Following this, it is determined whether or not each voltage signal input from the analog ports p1 to p3 becomes the threshold voltage for a count start (see step S17, FIG. 2(a)). In the step S17, the detected voltage obtained in the step S16 is compared with the threshold voltage to perform watching a time when the threshold voltage is reached or exceeded. When the detected voltage is smaller, NO is determined, and the step returns to S16 so that a new detected voltage is obtained again to repeat the determination again. When the value of the register becomes equal to the threshold voltage or larger, YES is determined, and the step goes to S18.

In the step S18, a rotation cycle signal is newly input from the analog ports p1 to p3, a rotation cycle is calculated and stored in the register, and, moreover, the phase angle data read out in the step S15 is converted to a trigger signal output time corresponding to the rotation cycle and stored in the resistor.

Following this, counting time is started (step S19), and the step goes to S20.

In the step S20, it is determined whether or not the count time reaches the trigger signal output time stored in the register. Here, the count time is compared to the trigger signal output time calculated in the step S18, the count is continued until the count time becomes equal to the trigger signal output time, and, when the count time becomes equal to the trigger signal output time, the trigger signal output instruction signal is output (step S21).

This trigger signal output instruction signal is output from the three I/O ports p4 to p6 and input to the trigger signal output circuit 29. In the trigger signal output circuit 29, the trigger signal is input to a gate of the thyristor 26 of the rectifying section 22A corresponding to the input of the trigger signal output instruction signal. Because of this, a phase angle control regarding the thyristor 26 can be performed, and the generated electric current can be varied and output so that the operation of the engine 1 saves energy.

According to the embodiment, an engine stop can be estimated by detecting a change of an engine rotational speed, and, if a stop at the exhaust stroke or the intake stroke is estimated, when the crankshaft is located in the bottom dead center to shift to the exhaust stroke, because the generated electric current of the rectifying section is greatly controlled, the load torque by power generation of the magneto generator becomes large and thus can be utilized as the braking torque of the engine to stop the engine at the exhaustion stroke, making a starting torque at a time of a next start small and reducing battery-consumed electric power at the start time as well as enhancing startability.

According to one embodiment, when it is estimated that the engine stops between the intake stroke and the compression stroke, the power generation amount of the rectifying section is controlled to be zero, the load torque provided by power generation of the magneto generator is made to become zero to exceed the compression stroke, and the stop estimation is postponed to the exhaust stroke or the intake stroke to increase the power generation amount of the rectifying section so that the engine is made to stop at the exhaust stroke or the intake stroke. A starting torque at a time of a next start thereby becomes small, reducing battery-consumed electric power at a start time as well as enhancing startability.

According to one embodiment, during a period between a start initiation and a start completion, because control of an engine start time power generation amount in which the power generation amount of the rectifying section becomes zero, or a weak electric current value requiredly smaller than a minimum electric current value of a generated electric current after a start is completed, as the load torque of the magneto generator is made to be zero or small, startability is enhanced, and battery-consumed electric power at a start time is reduced.

According to the embodiment, it is possible to variably control the rectifying section so that the generated electric current of the rectifying section corresponds to an operation mode of the engine as control of a normal operation time power generation amount. For example, by setting the phase angle to a specific value to correspond to a plurality of operation modes such as the start time, the idling state, the low speed rotation running state, the medium speed rotation running state, the high speed rotation running state, the acceleration state, and the deceleration state, it is possible to vary the power generation amount to an appropriate value corresponding to the operation mode every time an operation mode is changed, and it is possible to make the generated electric current correspond to a desired and appropriate load electric current according to the operation mode so that smooth operation, avoidance of a battery exhaustion, and energy saving can be achieved.

The present invention is not limited to one embodiment above but various changes can be performed in a range without deviating from a range of the general idea and technical concept thereof.

According to the embodiment, although a constitution is defined so that the rectifying section is variably controlled for the generated electric current of the rectifying section to correspond to the operation mode of the engine as control of the normal operation time power generation amount, the constitution may be defined so that the rectifying section is variably controlled for the generated electric current of the rectifying section to correspond to the load electric current of the electric appliance as control of the normal operation time power generation amount.

According to certain embodiments described herein, an engine stop is estimated by detecting a change of an engine rotational speed. If a stop at the exhaust stroke or the intake stroke is estimated, because a generated electric current of the rectifying section is greatly controlled when the exhaust stroke is effective, power generation control on the verge of a stop of the engine can be performed so that the engine stops at the exhaust stroke or the intake stroke. In other words, a load torque provided by the power generation of the magneto generator increases at the exhaust stroke or the intake stroke and can be utilized as a braking torque of the engine, and it is possible to stop the engine at the exhaust stroke. Because of this, a crank position is such that a start-up torque is small, startability is enhanced, and battery-consumed electric power at a start time can be reduced.

According certain embodiments, when it is estimated that the engine stops between the intake stroke and the compression stroke, control for making the power generation amount of the rectifying section become zero or about zero is performed to exceed the compression stroke by making the load torque by power generation of the magneto generator become zero or about zero so that the power generation amount of the rectifying section is increased by postponing the stop estimation from the exhaust stroke to the intake stroke to stop the engine at the exhaust stroke or the intake stroke. The starting torque at a time of a next start thereby is small to further enhance startability, and battery-consumed electric power at the start time is reduced.

In accordance with certain embodiments disclosed herein, during a period between a start initiation and a start completion, because control of an engine start time power generation amount in which the power generation amount of the rectifying section becomes zero or a weak electric current value requiredly smaller than a minimum electric current value of a generated electric current after a start is completed is performed, as a load torque of the magneto generator becomes zero or small, startability is enhanced, and battery-consumed electric power at a start time is reduced.

Additionally, as control of a normal operation time power generation amount, it is possible to variably control the rectifying section so that the generated electric current of the rectifying section corresponds to an operation mode of the engine.

Further with respect to certain embodiments, as control of a normal operation time power generation amount, it is possible to variably control the rectifying section so that the generated electric current of the rectifying section corresponds to a load electric current of the electric appliance.

Although these inventions have been disclosed in the context of a certain preferred embodiments and examples, it will be understood by those skilled in the art that the present inventions extend beyond the specifically disclosed embodiments to other alternative embodiments and/or uses of the inventions and obvious modifications and equivalents thereof In addition, while a number of variations of the inventions have been shown and described in detail, other modifications, which are within the scope of the inventions, will be readily apparent to those of skill in the art based upon this disclosure. It is also contemplated that various combinations or subcombinations of the specific features and aspects of the embodiments may be made and still fall within one or more of the inventions. Accordingly, it should be understood that various features and aspects of the disclosed embodiments can be combine with or substituted for one another in order to form varying modes of the disclosed inventions. Thus, it is intended that the scope of the present inventions herein disclosed should not be limited by the particular disclosed embodiments described above.

What is claimed is:

1. A power generation control device, comprising:
a magneto generator configured to generate an alternating electric current, the magneto generator rotatably driven by a crankshaft of an engine;
a generated electric current controller configured to rectify the alternating electric current into a direct current to provide a generated electric current, and to supply the generated electric current to at least one electric appliance, the generated electric current controller further configured to control a power generation amount to the at least one electric appliance; and
a battery connected in parallel with the generated electric current controller and with respect to the electric appliance;
wherein the generated electric current controller comprises
a rectifying section for converting the alternating electric current generated by the magneto generator to a direct current, and
a controlling section for controlling a power generation amount of the rectifying section, the controlling section comprising an exhaust stroke stop estimation time control module for calculating engine rotational speed and acceleration values based at least in part on a signal related to a rotation cycle of the crankshaft or the magneto generator, for estimating a stop position of the engine according to the rotational speed and the acceleration values, and for increasing the power generation amount of the rectifying section when the exhaust stroke stop estimation time control module estimates that the engine stops at an exhaust stroke.

2. The power generation control device according to claim 1, wherein the controlling section comprises a compression stroke stop estimation time control module for controlling the power generation amount of the rectifying section to become zero until a compression stroke is exceeded when the compression stroke estimation time control module estimates that the engine stops between an intake stroke and the compression stroke in which intake and exhaust valves of the engine are closed.

3. The power generation control device according to claim 1, wherein the controlling section further comprises a starting time control module for controlling the power generation amount of the rectifying section to become zero or a weak electric current value smaller than a minimum electric current value of a generated electric current after a start is completed during a period between a start initiation to a start completion of the engine.

4. The power generation control device according to claim 1, further comprising:
a normal operation time control module for identifying an operation mode according to rotational speed and acceleration calculated on the basis of the signal related to the rotation cycle of the crankshaft or the magneto generator, and for performing a control by which the generated electric current of the rectifying section corresponds to the operation mode.

5. The power generation control device according to claim 1, further comprising a normal operation time control module for performing a control by which a generated electric current of the rectifying section corresponds to a load electric current of the at least one electric appliance.

6. A power generation control device, comprising:
a magneto generator configured to generate an alternating electric current, the magneto generator rotatably driven by a crankshaft of an engine;
a generated electric current controller configured to rectify the alternating electric current into a direct current to provide a generated electric current, and to supply the generated electric current to at least one electric appliance, the generated electric current controller further configured to control a power generation amount to the at least one electric appliance; and
means for variably controlling a rectifying section of the generated electric current controller so that the generated electric current of the rectifying section corresponds to an operation mode of the engine and for estimating a stop position of the engine,
the generated electric current controller configured to increase the power generation amount of the rectifying section when the engine is estimated to stop at an exhaust stroke.

7. The device of claim 6, wherein the generated electric current controller is configured to control the power generation amount of the rectifying section to become zero when the engine is estimated to stop between an intake stroke and a compression stroke of the engine, the power generation amount controlled to be zero until the compression stroke is exceeded.

8. The device of claim 6, further comprising a battery connected in parallel with the generated electric current controller and with respect to the electric appliance.

9. A straddle-type vehicle comprising the power generation control device according to claim 1.

10. A method for controlling a power generation control device, comprising:
generating an alternating electric current via a generator driven by an engine;
rectifying the alternating electric current into a direct current to provide a generated electric current;
supplying the generated electric current to at least one electric appliance;
controlling a power generation amount to the at least one electric appliance;
calculating rotational speed and acceleration values of the engine based at least in part on a signal corresponding to a rotation cycle of a crankshaft of the engine or the generator;
estimating a stop position of the engine according to the calculated rotational speed and acceleration values; and
increasing the power generation amount when it is estimated that the stop position of the engine is at an exhaust stroke of the engine.

11. The method of claim 10, further comprising controlling the power generation amount to be zero until a compression stroke is exceeded when it is estimated that the stop position of the engine is between an intake stroke and a compression stroke of the engine.
